(19) United States
(12) Patent Application Publication
(10) Pub. No.: US 2025/0356645 A1
(43) Pub. Date: Nov. 20, 2025

(54) TRAINING FOR NEURAL SPLINE DEFORMATION

(71) Applicants: DISNEY ENTERPRISES, INC., Burbank, CA (US); ETH Zürich (Eidgenössische Technische Hochschule Zürich), Zürich (CH)

(72) Inventors: Yang ZHANG, Dubendorf (CH); Tunc Ozan AYDIN, Zürich (CH); Mingyang SONG, Zürich (CH); Siyu TANG, Zürich (CH)

(21) Appl. No.: 19/210,302

(22) Filed: May 16, 2025

Related U.S. Application Data
(60) Provisional application No. 63/649,282, filed on May 17, 2024.

(51) Int. Cl. G06V 10/82; G06V 10/75

(52) U.S. Cl. CPC G06V 10/82; G06V 10/75

(57) ABSTRACT

One embodiment of the present invention sets forth a technique for generating a neural deformation model. The technique includes inputting, into a machine learning model, (i) a set of canonical coordinates in a scene and (ii) one or more times included in a temporal trajectory of the scene. The technique also includes generating, via execution of the machine learning model, one or more sets of attributes associated with the set of canonical coordinates and the one or more times. The technique further includes computing one or more losses based on (i) a velocity included in the one or more sets of attributes and (ii) one or more representations of the scene at the one or more times, and training the machine learning model based on the one or more losses.

### CROSS-REFERENCE TO RELATED APPLICATIONS

This application claims the benefit of the U.S. Provisional Application titled “TECHNIQUES FOR IMPROVING GAUSSIAN SPLATTING WITH NEURAL SPLINE AND ARTISTIC EDITING,” filed on May 17, 2024, and having Ser. No. 63/649,282. The subject matter of this application is hereby incorporated herein by reference in its entirety.

### BACKGROUND

### Field of the Various Embodiments

Embodiments of the present disclosure relate generally to machine learning and computer vision and, more specifically, to training for neural spline deformation.

### Description of the Related Art

Films, video games, virtual reality (VR) systems, augmented reality (AR) systems, mixed reality (MR) systems, motion capture, and/or other types of applications frequently involve generating and/or making changes to depictions of 3D scenes over time. Traditionally, a visual representation of a given scene is generated and/or edited via a time-consuming, iterative, and/or laborious process. For example, a conventional visual effects workflow may involve a visual effects artist adding special effects and/or posing or animating a virtual character on a frame-by-frame basis.

More recently, advancements in machine learning and deep learning have led to the development of neural deformation models, which include deep neural networks that learn implicit representations of non-rigid and/or time-varying scenes. These neural deformation models commonly include coordinate neural networks that map coordinates in a canonical space to corresponding deformed coordinates at various temporal offsets. The deformed coordinates can then be used to render and/or reconstruct the corresponding scenes at the temporal offsets.

However, conventional neural deformation models are associated with a tradeoff between performance and ability to generalize to different scenarios. More specifically, a coordinate neural network may struggle to learn deformations that are smooth, coherent, and physically plausible across frames and/or time steps, which can lead to distortions in geometry and/or flickering or jumping artifacts. To mitigate these geometric distortions and/or artifacts, various inductive biases (e.g., priors, constraints, etc.) may be introduced in the design and/or training of a given neural deformation model. However, these inductive biases can limit the flexibility of the neural deformation model and/or the ability of the neural deformation model to novel scenarios (e.g., unseen deformations, topologies, types of objects, etc.). For example, a neural deformation model may be designed and/or trained under the assumption that local deformations are near-rigid, which allows the neural deformation model to learn physically plausible motion in articulated objects such as limbs. However, the neural deformation model may fail to generalize to complex motions associated with fluids, fabrics, volumetric media that can vary in density (e.g., smoke, clouds, fog, flames, etc.).

As the foregoing illustrates, what is needed in the art are more effective techniques for learning time-varying deformations in scenes using neural networks.

### SUMMARY

One embodiment of the present invention sets forth a technique for generating a neural deformation model. The technique includes inputting, into a machine learning model, (i) a set of canonical coordinates in a scene and (ii) one or more times included in a temporal trajectory of the scene. The technique also includes generating, via execution of the machine learning model, one or more sets of attributes associated with the set of canonical coordinates and the one or more times. The technique further includes computing one or more losses based on (i) a velocity included in the one or more sets of attributes and (ii) one or more representations of the scene at the one or more times, and training the machine learning model based on the one or more losses.

One technical advantage of the disclosed techniques relative to the prior art is the ability to model a temporally sparse trajectory representing a time-varying scene using a spline-based representation, which allows attributes of the time-varying scene to be interpolated in a smooth and/or spatially coherent manner. Consequently, renderings and/or other representations of scenes generated via the disclosed techniques may include a reduction in artifacts, geometric distortion, and/or temporal jitter when compared with representations of scenes that are generated using conventional neural deformation models. Another technical advantage of the disclosed techniques is that, because the spline-based representation allows motion to be modeled in a smooth and/or spatially coherent manner, the disclosed techniques may adapt to complex motions and/or novel scenarios better than conventional approaches that use priors and/or constraints to mitigate geometric distortions and/or artifacts. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the training engine and execution engine of FIG. 1, according to various embodiments.

FIG. 3A illustrates how the machine learning model of FIG. 2 maps a set of canonical coordinates and a query time to deformed attributes, according to various embodiments.

FIG. 3B illustrates how the machine learning model of FIG. 2 performs two types of time-variant spatial encoding, according to various embodiments.

FIG. 4A illustrates example style transfer results generated using the machine learning model of FIG. 2, according to various embodiments.

FIG. 4B illustrates example motion editing results generated using the machine learning model of FIG. 2, according to various embodiments.

FIG. 5 is a flow diagram of method steps for training a machine learning model to perform Gaussian splatting with neural spline deformation, according to various embodiments.

FIG. 6 is a flow diagram of method steps for determining a time-varying deformation associated with a scene, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

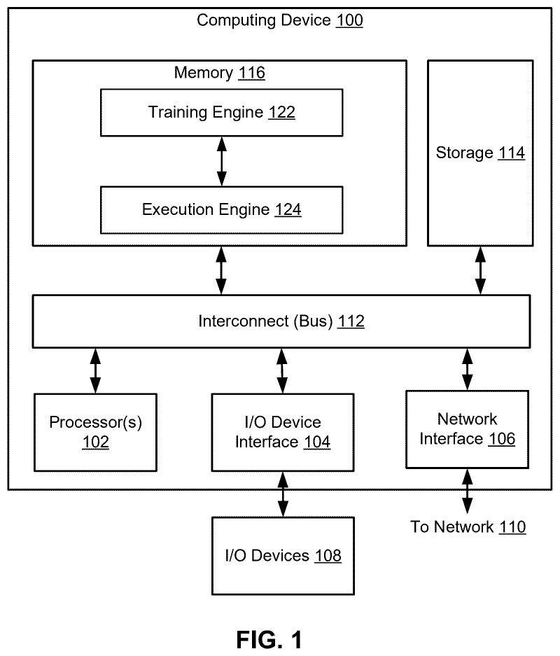

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in a memory 116.

It is noted that the computing device described herein is illustrative and that any other technically feasible configurations fall within the scope of the present disclosure. For example, multiple instances of training engine 122 and execution engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and execution engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In some embodiments, training engine 122 and execution engine 124 operate to train and execute one or more machine learning models to perform Gaussian splatting with neural spline deformation, in which the machine learning model(s) are used to map coordinates of 3D Gaussians (or another parameterization) representing a “canonical” depiction of a time-varying scene at a given time to deformed coordinates that represent the scene at other times. For example, the machine learning model(s) may be used to predict deformations to points on a canonical representation of a character in the scene as the character moves over time.

More specifically, training engine 122 and execution engine 124 model a trajectory of temporal changes to the 3D Gaussians as a spline curve that is divided into uniform time intervals by a set of equally spaced knots. A deformation of the scene at a given query time is determined by matching the query time to a time interval within the trajectory and generating time-variant spatial encodings of coordinates in the canonical space at the starting and ending times of the time interval. Learned features associated with the time-variant spatial encodings are aggregated and decoded by the machine learning model(s) into a position, velocity, and/or other attributes associated with the coordinates at the starting and ending times. The attributes associated with the starting and ending times are incorporated into a spline interpolation that is used to determine a corresponding position, velocity, and/or other attributes associated with the coordinates at the query time.

Training engine 122 trains the machine learning model(s) using a loss function that includes various regularization terms. One regularization term may be used to minimize the divergence in velocity of a point on the spline curve from the velocities of neighboring points. Another regularization term may be applied to the magnitude of the acceleration of the point to mitigate high-frequency temporal jitter. The loss function may also include a reconstruction loss that is used to minimize the error between a rendering (or another representation of the scene) generated using deformed attributes generated by the machine learning model and a corresponding ground truth image (or another representation) of the scene.

After training of the machine learning model is complete, execution engine 124 may use the trained machine learning model to generate deformed attributes for various positions in the canonical space at arbitrary query times. The deformed attributes may then be used to generate renderings, animations, 3D representations, and/or other representations of the scene at the query times. The deformed attributes may also, or instead, be used in motion editing, style transfer, and/or motion extension workflows associated with the scene. Training engine 122 and execution engine 124 are described in further detail below.

### Gaussian Splatting with Neural Spline Deformation

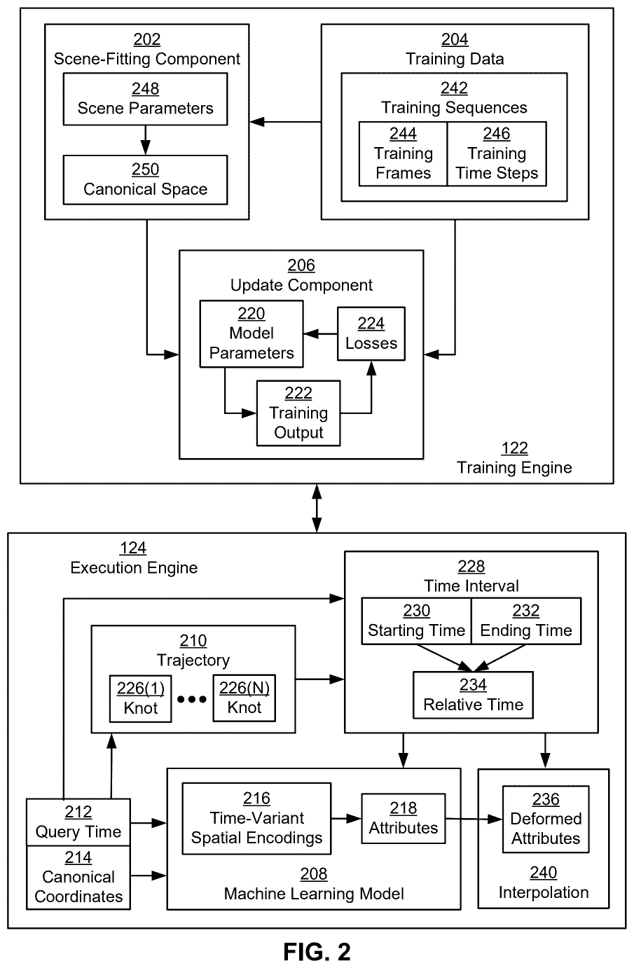

FIG. 2 is a more detailed illustration of training engine 122 and execution engine 124 of FIG. 1, according to various embodiments. As mentioned above, training engine 122 and execution engine 124 operate to train and execute a machine learning model 208 to perform Gaussian splatting with neural spline deformation.

In some embodiments, neural spline deformation is performed using a spline-based representation of points in a time-varying scene. In this spline-based representation, a temporal trajectory 210 from time steps t=0 to t=1 is uniformly divided into N−1 time intervals, resulting in N knots 226(1)-226(N) (each of which is referred to individually herein as knot 226) within a corresponding spline curve. The number of knots 226 may be determined using the following:

$$K \cdot N = T , \qquad ( 1 )$$

where T is the number of training frames 244 depicting the time-varying scene and K is a factor determined by the order of the polynomial defining each spline segment between two knots.

In one or more embodiments, the spline-based representation includes a cubie Hermite spline that includes consecutive third-order polynomial spline segments. Using Eq. 1 and K=2 for the cubic polynomial results in a theoretically well-determined fit of N=T/2.

Given a query time 212 t_{query}∈[0,1] and N knots 226, a time interval 228 to which this query time 212 belongs is determined, along with the corresponding starting time 230 and ending time 232, denoted as tₛₜₐᵣₜ and t_{end}, respectively. Query time 212 is then normalized to a relative time t̅∈[0,1] within this time interval 228.

An interpolation 240 function for the segment corresponding to time interval 228 is defined as:

$$p ( \overline{t} ) = ( 2 {\overline{t}}^{3} - 3 {\overline{t}}^{2} + 1 ) {p}_{0} + ( {\overline{t}}^{3} - 2 {\overline{t}}^{2} + \overline{t} ) {m}_{0} + ( - 2 {\overline{t}}^{3} + 3 {\overline{t}}^{2} ) {p}_{1} + ( {\overline{t}}^{3} - {\overline{t}}^{2} ) {m}_{1} , \qquad ( 2 )$$

where p₀ and p₁ represent positions at starting time 230 and ending time 232, respectively, to which canonical coordinates 214 are mapped, and m₀ and m₁ are corresponding starting and ending tangents (e.g., velocities) that can be independently optimized. The positions and tangents correspond to attributes 218 associated with canonical coordinates 214 at starting time 230 and ending time 232, which are predicted by machine learning model 208 based on canonical coordinates 214, starting time 230, and ending time 232.

In some embodiments, training engine 122 and execution engine 124 operate under a canonical-deformation framework, in which canonical coordinates 214 of points in a canonical space 250 associated with the scene at a given time (e.g., t=0) are mapped to deformed attributes 236 of the same points at query time 212 according to parameters p and m predicted by a coordinate neural network corresponding to machine learning model 208. This process can be expressed as:

$${X}^{c} = {\{ {x}_{i}^{c} , {x}_{i}^{c} ∈ {ℝ}^{3} \}}_{i = 1 , … , {N}_{p}} , \\ Δ {x}_{i} ( {t}_{start} ) , {\dot{x}}_{i} ( {t}_{start} ) = {Φ}_{θ} ( {x}_{i}^{c} , {t}_{start} ) , \\ {x}_{i} ( {t}_{start} ) = {x}_{i}^{c} + Δ {x}_{i} ( {t}_{start} ) \\ Δ {x}_{i} ( {t}_{end} ) , {\dot{x}}_{i} ( {t}_{end} ) = {Φ}_{θ} ( {x}_{i}^{c} , {t}_{end} ) , \\ {x}_{i} ( {t}_{end} ) = {x}_{i}^{c} + Δ {x}_{i} ( {t}_{end} ) , \\ {x}_{i} ( {t}_{query} ) = ℱ ( \overline{t} , {x}_{i} ( {t}_{start} ) , {\dot{x}}_{i} ( {t}_{start} ) , {x}_{i} ( {t}_{end} ) , {\dot{x}}_{i} ( {t}_{end} ) ) , \qquad ( 3 )$$

where

$${x}_{i}^{c}$$

denotes the spatial canonical coordinates 214 of points in canonical space 250 c, Nₚ is the total number of points in the scene within canonical space 250, and [symbol] ( . . . ) represents interpolation 240 function described in Eq. 2. Additionally, Φ represents machine learning model 208 parameterized by θ, which predicts (i) a spatial offset Δxᵢ(⋅) that can be combined with canonical coordinates 214 to produce a corresponding position xᵢ(⋅), and (ii) a tangent (e.g., velocity) \dot{x}ᵢ(⋅) associated with the position at a given time (e.g., tₛₜₐᵣₜ or t_{end}). To enhance clarity, p₀ and p₁ are substituted with xᵢ(tₛₜₐᵣₜ) and xᵢ(t_{end}), respectively, and m₀ and m₁ are substituted with \dot{x}ᵢ(tₛₜₐᵣₜ) and \dot{x}ᵢ(t_{end}), respectively.

The canonical deformation performed using machine learning model 208 and interpolation 240 may also be represented by the following example steps:

Input: Canonical coordinates:

$${X}^{c} = {\{ {x}_{i}^{c} ∈ {ℝ}^{3} \}}_{i = 1 , … , {N}_{p}}$$

query time: t_{query}∈[0.0,1.0],
Output: Deformed coordinates at query time t_{query}:

$$X ( {t}_{query} ) = {\{ {x}_{i} ( {t}_{query} ) ∈ {ℝ}^{3} \}}_{i = 1 , … , {N}_{p}} ,$$

Step 1. Calculate the length of time interval τ:

τ=1/(N−1) where N is the number of knots,

Step 2. Determine the starting and ending temporal index:

$${t}_{start} = CLAMP ( ⌊ {t}_{query} / τ ⌋ , min = 0 , max = N - 2 ) , \\ {t}_{end} = {t}_{start} + 1 ,$$

Step 3. Normalize to relative time:

$$\overline{t} = {t}_{query} \times ( N - 1 ) - {t}_{start}$$

Step 4. Calculate offset and tangent of starting time:

$$Δ {x}_{i} ( {t}_{start} ) , {\dot{x}}_{i} ( {t}_{start} ) = {Φ}_{θ} ( {x}_{i}^{c} , {t}_{start} ) , \\ {x}_{i} ( {t}_{sta rt} ) = {x}_{i}^{c} + Δ {x}_{i} ( {t}_{start} ) ,$$

Step 5. Calculate offset and tangent of ending time:

$$Δ {x}_{i} ( {t}_{end} ) , {\dot{x}}_{i} ( {t}_{end} ) = {Φ}_{θ} ( {x}_{i}^{c} , {t}_{end} ) \\ {x}_{i} ( {t}_{end} ) = {x}_{i}^{c} + Δ {x}_{i} ( {t}_{end} )$$

Step 6. Interpolate cubic polynomial to obtain position at query time:

$${x}_{i} ( {t}_{query} ) = ℱ ( \overline{t} , {x}_{i} ( {t}_{start} ) , {\dot{x}}_{i} ( {t}_{start} ) , {x}_{i} ( {t}_{end} ) , \dot{x} ( {t}_{end} ) ) = ( 2 {\overline{t}}^{3} - 3 {\overline{t}}^{2} + 1 ) {x}_{i} ( {t}_{start} ) + ( {\overline{t}}^{3} - 2 {\overline{t}}^{2} + \overline{t} ) {\dot{x}}_{i} ( {t}_{start} ) + ( - 2 {\overline{t}}^{3} + 3 {\overline{t}}^{2} ) {x}_{i} ( {t}_{end} ) + ( {\overline{t}}^{3} - {\overline{t}}^{2} ) \dot{x} ( {t}_{end} ) ,$$

Step 7. Derive velocity at query time:

$${v}_{i} ( {t}_{query} ) = ( 6 {\overline{t}}^{2} - 6 \overline{t} ) {x}_{i} ( {t}_{start} ) + ( 3 {\overline{t}}^{2} - 4 \overline{t} + 1 ) \dot{x} ( {t}_{start} ) + ( - 6 {\overline{t}}^{2} + 6 \overline{t} ) {x}_{i} ( {t}_{end} ) + ( 3 {\overline{t}}^{2} - 2 \overline{t} ) {\dot{x}}_{i} ( {t}_{end} ) ,$$

Step 8. Derive acceleration at query time:

$${a}_{i} ( {t}_{query} ) = ( 12 \overline{t} - 6 ) {x}_{i} ( {t}_{start} ) + ( 6 \overline{t} - 4 ) {\dot{x}}_{i} ( {t}_{start} ) + ( - 12 \overline{t} + 6 ) {x}_{i} ( {t}_{end} ) + ( 6 \overline{t} - 2 ) {\dot{x}}_{i} ( {t}_{end} )$$

More specifically, the canonical deformation is performed based on input that includes query time 212 t_{query} and Nₚ points represented by corresponding canonical coordinates 214 X^{c}. In step 1, the length of each time interval 228 τ within trajectory 210 is calculated based on the number of knots 226 N in the corresponding spline-based representation. In step 2, temporal indexes of starting time 230 tₛₜₐᵣₜ and ending time 232 t_{end} of a given time interval 228 that includes query time 212 are determined based on query time 212, the length of each time interval 228, and the number of knots 226. In step 3, query time 212 is normalized to relative time 234 t̅ within time interval 228.

In step 4, machine learning model 208 is used to generate an offset Δxᵢ(tₛₜₐᵣₜ) and a tangent \dot{x}ᵢ(tₛₜₐᵣₜ) associated with starting time 230 and canonical coordinates 214; the offset is combined with canonical coordinates 214 to obtain a position xᵢ(tₛₜₐᵣₜ) corresponding to canonical coordinates 214 at starting time 230. In step 5, machine learning model 208 is used to generate an offset Δxᵢ(t_{end}) and a tangent \dot{x}ᵢ(t_{end}) associated with ending time 232 and canonical coordinates 214; the offset is combined with canonical coordinates 214 to obtain a position xᵢ(t_{end}) corresponding to canonical coordinates 214 at ending time 232.

In step 6, interpolation 240 is performed using a cubic polynomial defining the spline segment corresponding to time interval 228 between starting time 230 and ending time 232 to obtain a position corresponding to canonical coordinates 214 at query time 212. In step 7, a velocity corresponding to canonical coordinates 214 at query time 212 is computed by taking the derivative of the cubic polynomial with respect to time. In step 8, an acceleration corresponding to canonical coordinates 214 at query time 212 is computed by taking the derivative of the velocity function in step 7 with respect to time.

The position, velocity, and acceleration computed in steps 6-8 may be included in deformed attributes 236 to which query time 212 and canonical coordinates 214 are mapped. As described in further detail below, these deformed attributes 236 may be used to train machine learning model 208; generate a rendering and/or reconstruction of the scene at query time 212; perform style transfer, motion extension, and/or motion editing related to the scene; and/or generate other output related to neural deformation of the scene.

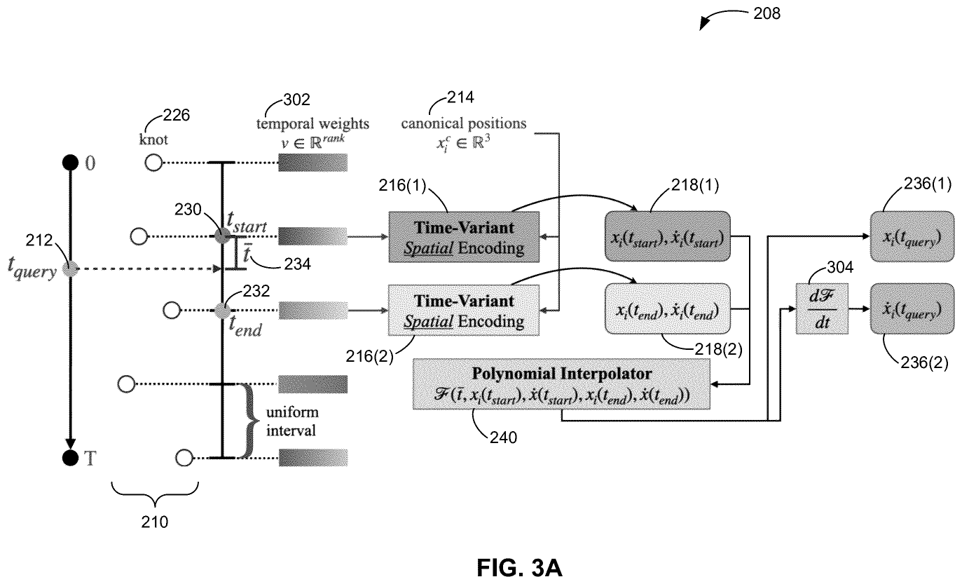

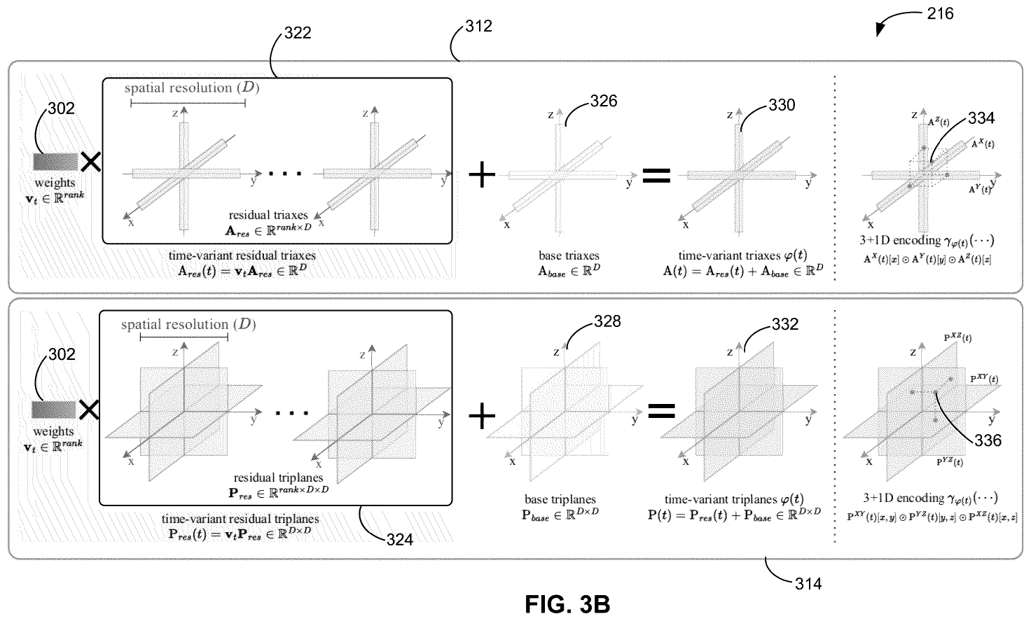

In one or more embodiments, machine learning model 208 generates attributes 218 based on time-variant spatial encodings 216 of canonical coordinates 214 and times (e.g., starting time 230, ending time 232, etc.). As described in further detail below with respect to FIGS. 3A-3B, time-variant spatial encodings 216 may be generated by decoupling temporal information associated with the times from spatial information associated with canonical coordinates 214, which can mitigate artifacts associated with generating time-varying representations of the scene based on the temporal information and spatial information.

FIG. 3A illustrates how machine learning model 208 of FIG. 2 maps a set of canonical coordinates 214 and query time 212 to deformed attributes 236(1)-236(2), according to various embodiments. As shown in FIG. 3A, query time 212 t_{query} corresponds to an arbitrary time step along trajectory 210, which is uniformly divided into N−1 time intervals by N knots 226. Query time 212 is matched to a corresponding time interval 228 that includes a given starting time 230 tₛₜₐᵣₜ that occurs before query time 212 and a given ending time 232 t_{end} that occurs after query time 212. Query time 212 is also converted into relative time 234 t̅ within time interval 228. This relative time 234 represents the proportion of time interval 228 that is spanned by the time between starting time 232 and query time 212.

A numeric index for starting time 230 is used to retrieve a first vector vₜ_{ₛₜₐᵣₜ}∈ [symbol] ^{rank} storing a first set of temporal weights 302. A different numeric index for ending time 232 is used to retrieve a second vector vₜ_{_{end}}∈ [symbol] ^{rank} storing a second set of temporal weights 302. A first time-variant spatial encoding 216(1) associated with starting time 230 is generated from the first vector and the set of canonical coordinates 214

$${x}_{i}^{c} ∈ {ℝ}^{3} .$$

A second time-variant spatial encoding 216(2) associated with ending time 232 is generated from the second vector and the same set of canonical coordinates 214.

In some embodiments, and as described in further detail below with respect to FIG. 3B, each time-variant spatial encoding 216(1) or 216(2) corresponds to a projection of a four-dimensional (4D) input that includes a given time (e.g., starting time 230 or ending time 232) and the set of canonical coordinates 214 onto triplanes, triaxes, and/or another type of topological space. This projection is used to retrieve and/or interpolate features associated with query time 212 and canonical coordinates 214 from the topological space. The features are aggregated and decoded by one or more layers in machine learning model 208 (e.g., a multi-layer perceptron (MLP)) into attributes 218 that include a position xᵢ(⋅) and a velocity \dot{x}ᵢ(⋅) associated with the set of canonical coordinates 214 at the time. More specifically, time-variant spatial encoding 216(1) is used to generate a first set of attributes 218(1) associated with canonical coordinates 214 and starting time 230, and time-variant spatial encoding 216(2) is used to generate a second set of attributes 218(1) associated with canonical coordinates 214 and ending time 232.

A polynomial interpolation 240 is performed using attributes 218(1) and attributes 218(2) to produce a first deformed attribute 236(1) xᵢ(t_{query}) corresponding to a new position associated with the set of canonical coordinates 214 at query time 212. A derivative 304 of the cubic polynomial used in interpolation 240 is used to compute a second deformed attribute 236(2) \dot{x}ᵢ(t_{query}) corresponding to a velocity associated with the canonical coordinates 214 at query time.

FIG. 3B illustrates how machine learning model 208 of FIG. 2 performs two types 312 and 314 of time-variant spatial encoding 216, according to various embodiments. In one or more embodiments, the operation of machine learning model 208 using each type 312 and 314 of time-variant spatial encoding 216 is represented using the following:

$${Φ}_{θ} ( {γ}_{φ ( t )} ( x ) , {γ}_{φ ( t )} ( y ) , {γ}_{φ ( t )} ( z ) ) \qquad ( 4 )$$

where γ(⋅) represents an encoding (e.g., triplane, triaxis, etc.), γ_{φ(t)}(⋅) denotes time-variant encoding, and φ(t) is a temporal signal injection function that varies based on the specific design of γ(⋅). Time-variant spatial encoding 216 is generated from a 4D input that includes three spatial coordinates (e.g., canonical coordinates 214) x, y, and z and a time t. Because both types 312 and 314 of time-variant spatial encoding 216 decouple encoding of temporal information from encoding of spatial information (e.g., by using the temporal information to adjust weights in a spatial encoding), time-variant spatial encoding 216 may result in deformations that that are smoother, more coherent, and/or more physically plausible than encodings generated via previous approaches that concatenate spatial and temporal signals as encoding inputs (e.g., Φ_{θ}(γ(x), γ(y), γ(z), γ(t))).

Additionally, each type 312 and 314 of time-variant spatial encoding 216 can incorporate low-rank decomposition in the temporal domain for compactness and implicit regularization:

$$ϕ ( t ) = {b}_{b a s e} + {\sum }_{r = 1}^{r a n k} {ν}_{t} [ r ] \cdot {B}_{r e s} [ r ] \qquad ( 5 )$$

where [r] denotes element indexing, vₜ∈ [symbol] ^{rank} represents trainable temporal weights 302 associated with time t, Bᵣₑₛ∈ [symbol] ^{rank× . . .} are residuals (e.g., residual triaxes 322 or residual triplanes 324) defined with respect to a base b_{base} (e.g., base triaxes 326 or base triplanes 328), and the base corresponds to a time-invariant encoding.

As shown in FIG. 3B, one type 312 of time-variant spatial encoding 216 involves computing time-variant residual triaxes Aᵣₑₛ(t)=vₜAᵣₑₛ∈ [symbol] ^{D} (where D is an axis spatial resolution) as a weighted sum of a vector of temporal weights 302 vₜ∈ [symbol] ^{rank} associated with time t and multiple residual triaxes 322 Aᵣₑₛ∈ [symbol] ^{rank×D}. The time-variant residual triaxes are summed with time-invariant base triaxes 326 A_{base}∈ [symbol] ^{D} to produce a set of time-variant triaxes 330 A(t)=Aᵣₑₛ(t)+A_{base}∈ [symbol] ^{D}, which represent the temporal signal injection function φ(t). A corresponding time-variant spatial encoding 216 A^{X}(t)[x]⊙A^{Y}(t)[y]⊙A^{Z}(t)[z] (where ⊙ is the Hadamard product) is generated by sampling and aggregating features 334 at specific x, y, and z positions along the respective axes in time-variant triaxes 330 using A′(t)[⋅]. Each set of features 334 sampled from a given axis represents a time-variant encoding γ_{φ(t)}(⋅) of the corresponding input.

In some embodiments, time-variant triaxes 330 are generated using the following:

$${A}^{X} ( t ) = {A}_{b a s e}^{X} + {\sum }_{r = 1}^{r a n k} {v}_{t} [ r ] \cdot {A}_{r e s}^{X} [ r ] , \qquad ( 6 )$$

$${A}^{Y} ( t ) = {A}_{b a s e}^{Y} + {\sum }_{r = 1}^{r a n k} {v}_{t} [ r ] \cdot {A}_{r e s}^{Y} [ r ] ,$$

$${A}^{Z} ( t ) = {A}_{b a s e}^{Z} + {\sum }_{r = 1}^{r a n k} {v}_{t} [ r ] \cdot {A}_{r e s}^{Z} [ r ] ,$$

$${A}^{.} ( t ) ∈ {ℝ}^{D} ,$$

where A′(t) represents an X, Y, or Z axis storing features at time t to be queried by the corresponding coordinate, A′_{base}∈ [symbol] ^{D} denotes a base X, Y, or Z axis, and A′ᵣₑₛ[r]∈ [symbol] ^{rank×D} denotes a residual X, Y, or Z axis.

Element-wise multiplication can be used to aggregate features 334 queried from different axes:

$$feat ( x , t ) = {A}^{X} ( t ) [ x ] , \qquad ( 7 )$$

$$feat ( y , t ) = {A}^{Y} ( t ) [ y ] ,$$

$$feat ( z , t ) = {A}^{Z} ( t ) [ z ] ,$$

$$feat ( x , y , z , t ) = feat ( x , t ) ⊙ feat ( y , t ) ⊙ feat ( z , t ) ,$$

$$feat ( x , y , z , t ) ∈ {ℝ}^{d} ,$$

where A′(t)[⋅] represents retrieval of features 336 from a given axis in time-variant triaxes 330 at a corresponding one-dimensional (1D) position and d is the dimension of features stored in grid vertices of time-variant triaxes 330.

The other type 314 of time-variant spatial encoding 216 involves computing time-variant residual triplanes Pᵣₑₛ(t)∈vₜPᵣₑₛ [symbol] ^{D×D} (where D is a spatial resolution associated with a plane) as a weighted sum of the vector of temporal weights 302 vₜ∈ [symbol] ^{rank} and multiple residual triplanes 324 Pᵣₑₛ∈ [symbol] ^{rank×D×D}. The time-variant residual triplanes are summed with time-invariant base triplanes 328 P_{base}∈ [symbol] ^{D×D} to produce a set of time-variant triplanes 332 P(t)=Pᵣₑₛ(t)+P_{base}∈ [symbol] ^{D×D}, which represent the temporal signal injection function φ(t). A corresponding time-variant spatial encoding 216 P^{XY}(t)[x, y]⊙P^{YZ}(t)[y, z]⊙P^{XZ}(t)[x, z] is generated by sampling and aggregating features 336 at specific (x, y), (y, z), and (x, z) positions within the respective planes in time-variant triplanes 332 using P′(t)[⋅]. Each set of features 336 sampled from a given plane represents a time-variant encoding γ_{φ(t)}(⋅) of the corresponding combination of inputs.

In some embodiments, time-variant triplanes 332 are generated using the following:

$${P}^{X Y} ( t ) = {P}_{b a s e}^{X Y} + {\sum }_{r = 1}^{r a n k} {v}_{t} [ r ] \cdot {P}_{r e s}^{X Y} [ r ] , \qquad ( 8 )$$

$${P}^{Y Z} ( t ) = {P}_{b a s e}^{Y Z} + {\sum }_{r = 1}^{r a n k} {v}_{t} [ r ] \cdot {P}_{r e s}^{Y Z} [ r ] ,$$

$${P}^{X Z} ( t ) = {P}_{b a s e}^{X Z} + {\sum }_{r = 1}^{r a n k} {v}_{t} [ r ] \cdot {P}_{r e s}^{X Z} [ r ] ,$$

$${P}^{..} ( t ) ∈ {ℝ}^{D \times D}$$

where P″(t) represents a plane (e.g., XY, YZ, or XZ) storing features to be queried by the corresponding coordinates,

$${P}_{base}^{..} ∈ {ℝ}^{D \times D}$$

denotes a base XY, YZ, or XZ plane, and

$${P}_{res}^{..} [ r ]$$

denotes a residual xx, YZ, or XZ plane.

Element-wise multiplication can be used to aggregate features queried from different axes:

$$feat ( x , y , t ) = {P}^{X Y} ( t ) [ x , y ] , \qquad ( 9 )$$

$$f eat ( y , z , t ) = {P}^{Y Z} ( t ) [ y , z ] ,$$

$$feat ( x , z , t ) = {P}^{X Z} ( t ) [ x , z ] ,$$

$$feat ( x , y , z , t ) = feat ( x , y , t ) ⊙ feat ( y , z , t ) ⊙ feat ( x , z , t ) ,$$

$$feat ( x , y , z , t ) ∈ {ℝ}^{d} ,$$

where P″(t) [⋅, ⋅] represents retrieval of features 336 from a given plane in time-variant triplanes 332 at a corresponding two-dimensional (2D) position by interpolating from neighboring grid vertices and d is the dimension of features stored in grid vertices of time-variant triplanes 332.

In both types 312 and 314 of time-variant spatial encoding 216, aggregated features 334 and/or 336 feat (x, y, z, t) are concatenated from multiple levels along the channel dimension. The concatenated features 334 and/or 336 are then decoded by one or more layers in machine learning model 208 (e.g., a two-layer MLP) into offsets, tangents, and/or other attributes 218 associated with the corresponding 4D input.

Returning to the discussion of FIG. 2, training engine 122 trains machine learning model 208 using training data 204 that includes one or more training sequences 242 of training frames 244 paired with training time steps 246. For example, a given training sequence may include training frames 244 from a video (or another visual and/or spatial representation) of the scene. Each training frame may be associated with a corresponding training time step that corresponds to a temporal point along trajectory 210.

A scene-fitting component 202 in training engine 122 determines scene parameters 248 that fit a “canonical” depiction of the scene at a given time (e.g., t=0) to points in canonical space 250. For example, scene-fitting component 202 may use Gaussian splatting to represent the canonical depiction of the scene at the time using radiance fields parameterized by anisotropic 3D Gaussians. Each 3D Gaussian may be associated with scene parameters 248 that are iteratively optimized based on one or more training frames 244 that depict the scene at the given time. These parameters may include (but are not limited to) positions (e.g., canonical coordinates 214) in canonical space 250, covariance, color, and/or transparency. As the 3D Gaussians are optimized, the 3D Gaussians are densified to better represent the scene. Scene-fitting component 202 may also, or instead, represent the scene at the time using a neural radiance field (NeRF), signed distance function, neural point cloud, neural mesh, and/or other parameterizations.

An update component 206 in training engine 122 trains machine learning model 208 using scene parameters 248 generated by scene-fitting component 202, training frames 244 in training data 204, and training time steps 246 in training data 204. More specifically, update component 206 inputs a given training time step associated with a corresponding training frame and a set of one or more positions in canonical space 250 (e.g., from scene parameters 248 determined by scene-fitting component 202) into machine learning model 208. Update component 206 uses machine learning model 208 to generate training output 222 that includes predictions of deformed attributes 236 corresponding to the inputted training time step and position(s). Update component 206 computes one or more losses 224 using training output 222, scene parameters 248, training frames 244, and/or other data. Update component 206 also uses a training technique (e.g., gradient descent and backpropagation) to update model parameters 220 of machine learning model 208 (and optionally scene parameters 248 associated with the scene) based on losses 224. Update component 206 repeats the process with additional training time steps 246 and/or positions in canonical space 250 until model parameters 220 converge, losses 224 fall below a threshold, and/or another condition indicating that training of machine learning model 208 is complete is met.

In some embodiments, losses 224 include a reconstruction loss that is computed between an image rendered using training output 222 and a ground truth training frame for the corresponding training time step:

$${ℒ}_{r e c o n} = ( 1 - λ ) L 1 ( I , \hat{I} ) + λ {ℒ}_{SSIM} ( I , \hat{I} ) \qquad ( 10 )$$

where I is the ground truth training frame from training data 204, Î is the rendered image that is generated using predictions of deformed attributes 236 in training output 222, L1 is an L1 (e.g., mean absolute error) loss, and [symbol] _{SSIM} is a structural similarity index measure (SSIM). Additionally, λ is a hyperparameter that controls the relative weighting of the L1 and SSIM loss terms.

As discussed above, the velocity of a point on the spline can be determined by taking the derivative with respect to time of Equation 2:

$$v ( \overline{t} ) = ( 6 {\overline{t}}^{2} - 6 \overline{t} ) {p}_{0} + ( 3 {\overline{t}}^{2} - 4 \overline{t} + 1 ) {m}_{0} + ( - 6 {\overline{t}}^{2} + 6 \overline{t} ) {p}_{1} + ( 3 {\overline{t}}^{2} - 2 \overline{t} ) {m}_{1} , \qquad ( 11 )$$

This velocity can be used to compute a velocity loss

$${ℒ}_{v}^{i}$$

that minimizes the divergence in the velocity from the velocities of neighboring points:

$${ℒ}_{v}^{i} = {\sum }_{j ∈ {𝒩}_{k} ( i )} {w}_{i j} {‖ {v}_{i} - {v}_{j} ‖}_{2}^{2} , \qquad ( 12 )$$

where i is an index of points, [symbol] ₖ(i) represents the k nearest neighbors of point i (e.g., in canonical space 2500, j is a local index in the neighborhood of i, and wᵢⱼ is a weight that is proportional to the relative distance between points i and j.

Further, the derivative of Equation 11 can be taken with respect to time to obtain an analytical acceleration of a point on the spline:

$$a ( \overline{t} ) = ( 12 \overline{t} - 6 ) {p}_{0} + ( 6 \overline{t} - 4 ) {m}_{0} + ( - 12 \overline{t} + 6 ) {p}_{1} + ( 6 \overline{t} - 2 ) {m}_{1} . \qquad ( 13 )$$

An additional acceleration loss

$${ℒ}_{a c c}^{i}$$

can be used to regularize the acceleration of the points:

$${ℒ}_{a c c}^{i} = \vert {a}_{i} \vert . \qquad ( 14 )$$

The final loss function may include a weighted combination of the reconstruction loss, velocity loss, and acceleration loss:

$$ℒ = {ℒ}_{r e c o n} + α {ℒ}_{v} + β {ℒ}_{acc} , \qquad ( 15 )$$

where α and β are hyperparameters that control the relative strength of velocity and acceleration regularization, respectively.

After training of machine learning model 208 is complete, machine learning model 208 may be used to generate deformed attributes 236 for various combinations of query time 212 and canonical coordinates 214. These deformed attributes 236 may be combined with scene parameters 248 of the corresponding portions of the scene to generate renderings, animations, 3D representations, and/or other representations of the scene at various times.

In some embodiments, machine learning model 208 is used to edit and/or extend the scene beyond the representations depicted in training frames 244. For example, velocities of points for a given query time 212 that is set to the last time step in trajectory 210 may be used to extend the motion of an object in the scene beyond the last time step (e.g., by propagating the positions of the points based on the velocities).

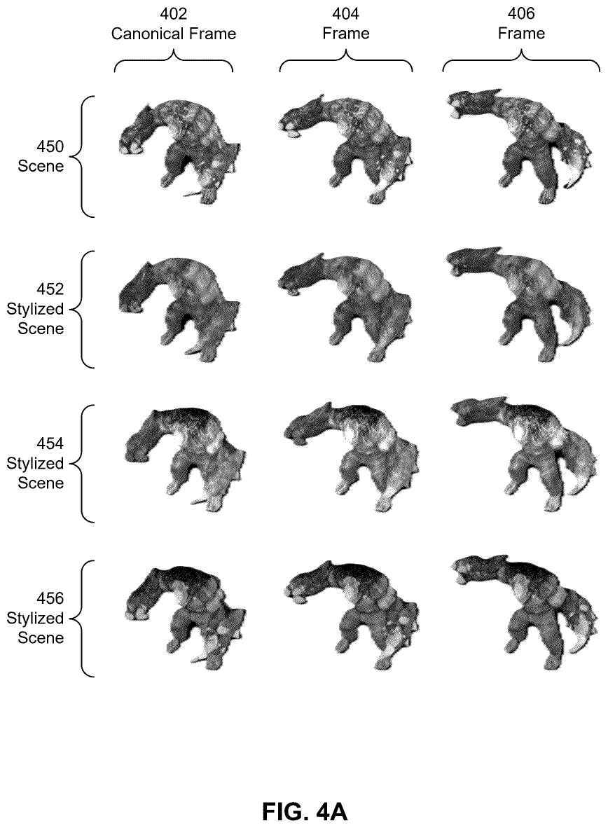

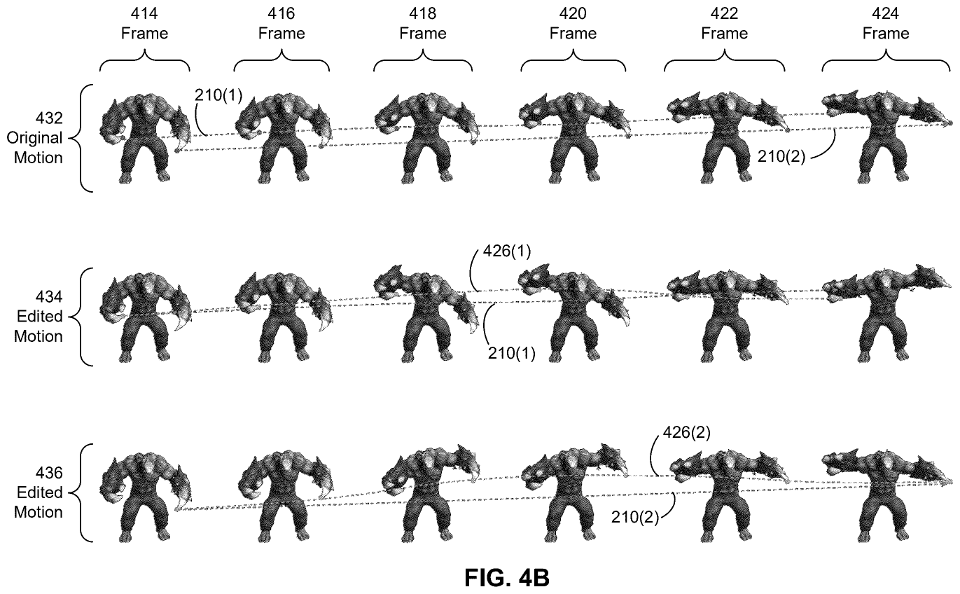

In another example, style transfer may be performed by updating colors, textures, and/or other scene parameters 248 that affect the “canonical” depiction of the scene and using machine learning model 208 to generate additional depictions that incorporate the updated scene parameters 248. Style transfer using neural spline transfer is described in further detail below with respect to FIG. 4A.

In a third example, motion editing may be performed by editing one or more key training frames 244 in training sequences 242, optionally updating scene parameters 248 based on the edited training frames 244 (e.g., when the edited training frames 244 include one or more frames that are used to generate the canonical representation of the scene), retraining machine learning model 208 using the edited training frames 244, and using the retrained machine learning model 208 to generate new representations of the scene that incorporate poses and/or other attributes of the edited training frames 244. Motion editing using neural spline transfer is described in further detail below with respect to FIG. 4B.

FIG. 4A illustrates example style transfer results generated using machine learning model 208 of FIG. 2, according to various embodiments. As shown in FIG. 4A, a time-varying scene 450 includes a canonical frame 402 depicting a character at a given time step (e.g., the temporal start of the time-varying scene 450). This canonical frame 402 is used to generate a corresponding set of scene parameters 248 in canonical space 250. Machine learning model 208 is used to map canonical coordinates 214 of 3D Gaussians and/or other representations parameterized by scene parameters 248 to deformed attributes 236 associated with two additional other time steps in the time-varying scene 450. These deformed attributes 236 may then be used to generate additional frames 404 and 406 that correspond to renderings and/or other representations of the character at the additional time steps.

The same deformed attributes 236 may also be used to generate stylized scenes 452, 454, and 456 that include the same poses as those in trajectory 210 and different textures for the character. More specifically, each stylized scene 452, 454, and 456 may be initialized by updating scene parameters 248 to reflect a new set of colors and/or textures for the character and/or by generating a new set of scene parameters 248 from a corresponding canonical frame 402 that depicts the character with the new set of colors and/or textures. Additional frames 404 and 406 in each stylized scene 452, 454, and 456 may then be generated by combining the updated and/or new scene parameters 248 with the same deformed attributes 236 used to generate frames 404 and 406 in scene 450.

FIG. 4B illustrates example motion editing results generated using machine learning model 208 of FIG. 2, according to various embodiments. As shown in FIG. 4B, an original motion 432 of a character includes two trajectories 210(1)-210(2) of points on the character over a number of frames 414, 416, 418, 420, 422, and 424. Trajectory 210(1) may represent the movement of a first point on the right arm of the character across frames 414, 416, 418, 420, 422, and 424, and trajectory 210(2) may represent the movement of a second point on the left arm of the character across frames 414, 416, 418, 420, 422, and 424.

The representation of the character in some or all frames 414, 416, 418, 420, 422, and 424 may be generated via a spline interpolation of attributes 218 associated with key frames depicting the character at the same time steps and/or different time steps. For example, the key frames may depict the character at time steps indexed by 0, 75, and 150, and original motion 432 may include frames 414, 416, 418, 420, 422, and 424 showing the character at time steps indexed by 0, 30, 60, 90, 120, and 150. Thus, frames 414 and 424 may be generated using attributes 218 associated with the corresponding key frames, and each frame 416, 418, 420, and 422 may be generated using deformed attributes 236 that are computed via interpolation 240 of attributes 218 associated with a corresponding pair of key frames.

Two edited motions 434 and 436 for the same character are generated by editing some or all key frames used to generate frames 414, 416, 418, 420, 422, and 424 in original motion 432. For example, edited motion 434 may be generated by modifying the positions of the left and right arms in the character at two key frames corresponding to time steps 75 and 150, and edited motion 436 may be generated by modifying the positions of the left and right arms in the character at one key frame corresponding to time step 75. The edited key frame(s) associated with each edited motion 434 and 436 may be used to retrain machine learning model 208. The retrained machine learning model may then be used to generate new attributes 218 and/or new deformed attributes 236 that can be used to produce corresponding new frames 414, 416, 418, 420, 422, and 424 depicting the edited motion.

Edited motion 434 includes a new trajectory 426(1) for the first point on the right arm of the character, which deviates from the corresponding trajectory 210(1) in original motion 432 after frame 414. Edited motion 436 includes a new trajectory 426(2) for the second point on the left arm of the character, which deviates from the corresponding trajectory 210(2) in original motion 432 after frame 414. Frames 414, 416, 418, 420, 422, and 424 in each edited motion 434 and 436 may be generated from attributes 218 and/or deformed attributes 236 associated with these new trajectories 426(1) and 426(2) instead of requiring additional edits to the character beyond those made to the key frame(s).

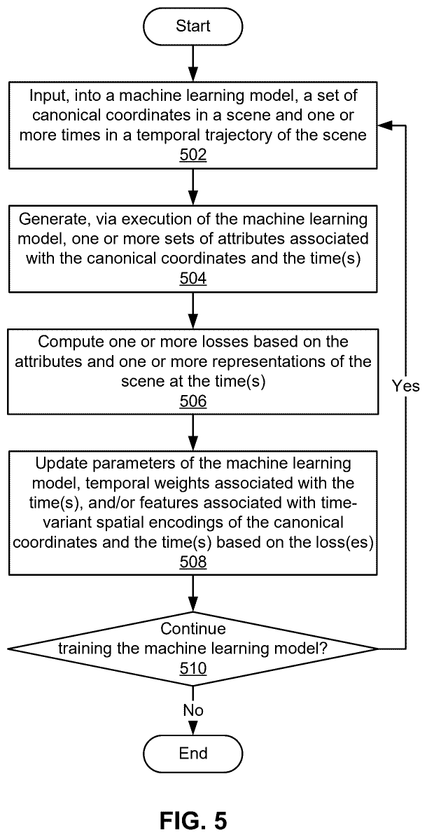

FIG. 5 is a flow diagram of method steps for training a machine learning model to perform Gaussian splatting with neural spline deformation, according to various embodiments. Although the method steps are described in conjunction with the systems of FIGS. 1-2, persons skilled in the art will understand that any system configured to perform some or all of the method steps in any order falls within the scope of the present disclosure.

As shown, in step 502, training engine 122 inputs, into a machine learning model, a set of canonical coordinates in a scene and one or more times in a temporal trajectory of the scene. The canonical coordinates may be associated with a set of 3D Gaussians and/or another parameterization of the scene. The time(s) may include one or more time steps associated with frames that depict the scene.

In step 504, training engine 122 generates, via execution of the machine learning model, one or more sets of attributes associated with the canonical coordinates and the time(s). For example, training engine 122 may generate a time-variant spatial encoding of a 4D input that includes three canonical coordinates and a given time. The time-variant spatial encoding may be generated using a set of temporal weights associated with the time, a set of residual encodings, and/or a base encoding. Training engine 122 may aggregate features associated with the time-variant spatial encoding and use the machine learning model to decode the features into a corresponding position associated with the canonical coordinates at the time. Training engine 122 may also use a spline-based representation of the temporal trajectory to analytically derive a velocity and/or acceleration associated with the canonical coordinates at the time.

In step 506, training engine 122 computes one or more losses based on the attributes and one or more representations of the scene at the time(s). For example, training engine 122 may compute a reconstruction loss between renderings of the scene at the time(s) that are produced using the parameterization of the scene and attributes generated in step 504 and ground truth renderings of the scene at the same time(s). Training engine 122 may also, or instead, compute a velocity loss between the velocity and a set of velocities associated with points in a neighborhood of the canonical coordinates. Training engine 122 may also, or instead, compute an acceleration loss from the magnitude of the acceleration.

In step 508, training engine 122 updates parameters of the machine learning model, temporal weights associated with the time(s), and/or features associated with time-variant spatial encodings of the canonical coordinates and the time(s) based on the loss(es). For example, training engine 122 may use an optimization technique with different learning rates for the parameters of the machine learning model, temporal weights, and features to update the parameters of the machine learning model, temporal weights, and features based on a weighted sum of the loss(es).

In step 510, training engine 122 determines whether or not to continue training the machine learning model. For example, training engine 122 may determine that training of the machine learning model is to continue until a certain number of training steps, iterations, batches, and/or epochs has been performed; the loss(es) fall below a threshold; parameters of the machine learning model converge; and/or another condition is met.

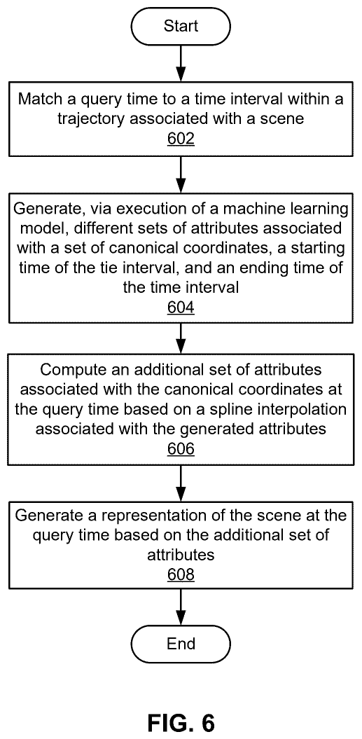

While training engine 122 determines that training of the machine learning model is to continue, training engine 122 repeats steps 502, 504, 506, 508, and 510. For example, training engine 122 may continue training the machine learning model using additional canonical coordinates and/or times in the temporal trajectory. Once training engine 122 determines in step 510 that training of the machine learning model is complete, the trained machine learning model may be used to generate attributes and/or representations of the scene at arbitrary times, as described in further detail below with respect to FIG. 6.

FIG. 6 is a flow diagram of method steps for determining a time-varying deformation associated with a scene, according to various embodiments. Although the method steps are described in conjunction with the systems of FIGS. 1-2, persons skilled in the art will understand that any system configured to perform some or all of the method steps in any order falls within the scope of the present disclosure.

As shown, in step 602, execution engine 124 matches a query time to a time interval within a trajectory associated with the scene. For example, the trajectory may include a spline-based representation that is divided into uniform time intervals by equally spaced knots. Execution engine 124 may identify the time interval as having a starting time that occurs before the query time and an ending time that occurs after the query time.

In step 604, execution engine 124 generates, via execution of a machine learning model, different sets of attributes associated with a set of canonical coordinates, the starting time of the time interval, and the ending time of the time interval. For example, execution engine 124 may generate a time-variant spatial encoding of three canonical attributes specifying a 3D position in a canonical space and a given time (e.g., the starting time or ending time). The time-variant spatial encoding may be generated by combining a vector of temporal weights associated with the time, a set of residual encodings (e.g., residual triaxes or triplanes), and a time-invariant base encoding (e.g., base triaxes or triplanes). Features associated with the time and canonical attributes may be retrieved and/or interpolated using the time-variant spatial encoding (e.g., from corresponding positions in time-variant triaxes and/or triplanes corresponding to the time-variant spatial encoding), and an aggregation of the features may be decoded by one or more layers of the machine learning model into a corresponding set of attributes. The attributes may include a position, velocity, and/or acceleration for each of the starting time and the ending time.

In step 606, execution engine 124 computes an additional set of attributes associated with the canonical coordinates at the query time based on a spline interpolation associated with the generated attributes. For example, execution engine 124 may determine a “relative time” within the time interval that corresponds to the query time. Execution engine 124 may also perform a polynomial interpolation using the relative time and the attributes generated in step 604 to determine a “deformed” position associated with the canonical coordinates at the query time. Execution engine 124 may also perform an analytical derivation of the velocity and/or acceleration associated with the canonical coordinates at the query time using the first and/or second derivatives of the polynomial with respect to time.

In step 608, execution engine 124 generates a representation of the scene at the query time based on the additional set of attributes. For example, execution engine 124 may use deformed positions associated with multiple canonical coordinates at the query time to generate a rendering, animation, 3D representation, and/or another representation of the scene at the query time. Execution engine 124 may also, or instead, use the additional attributes to extend the motion of the scene past the temporal end of the trajectory. Execution engine 124 may also, or instead, use the deformed attributes with edits to appearances and/or poses of the scene at one or more key frames to perform style transfer and/or motion editing associated with the scene.

In sum, the disclosed techniques perform Gaussian splatting with neural spline deformation, in which a machine learning model is used to map coordinates of 3D Gaussians (or another parameterization) representing a “canonical” depiction of a time-varying scene at a given time to deformed coordinates that represent the scene at other times. For example, the machine learning model may be used to predict deformations to points on a canonical representation of a character in the scene as the character moves over time. A trajectory of temporal changes to the 3D Gaussians is modeled as a spline curve that is divided into uniform time intervals by a set of equally spaced knots. A deformation of the scene at a given query time is determined by matching the query time to a time interval within the trajectory and generating time-variant spatial encodings of coordinates in the canonical space at the starting and ending times of the time interval. Learned features associated with the time-variant spatial encodings are aggregated and decoded by the machine learning model into a position, velocity, and/or other attributes associated with the coordinates at the starting and ending times. The attributes associated with the starting and ending times are incorporated into a spline interpolation that is used to determine a corresponding position, velocity, and/or other attributes associated with the coordinates at the query time.

The machine learning model is trained using a loss function that includes various regularization terms. One regularization term may be used to minimize the divergence in velocity of a point on the spline curve from the velocities of neighboring points. Another regularization term may be applied to the magnitude of the acceleration of the point to mitigate high-frequency temporal jitter. The loss function may also include a reconstruction loss that is used to minimize the error between a rendering (or another representation of the scene) generated using deformed attributes generated by the machine learning model and a corresponding ground truth image (or another representation) of the scene.

After training of the machine learning model is complete, the trained machine learning model may be used to generate deformed attributes for various positions in the canonical space at arbitrary query times. The deformed attributes may then be used to generate renderings, animations, 3D models, and/or other representations of the scene at the query times. The deformed attributes may also, or instead, be used in motion editing, style transfer, and/or motion extension workflows associated with the scene.

One technical advantage of the disclosed techniques relative to the prior art is the ability to model a temporally sparse trajectory representing a time-varying scene using a spline-based representation, which allows attributes of the time-varying scene to be interpolated in a smooth and/or spatially coherent manner. Consequently, renderings and/or other representations of scenes generated via the disclosed techniques may include a reduction in artifacts, geometric distortion, and/or temporal jitter when compared with representations of scenes that are generated using conventional neural deformation models. The disclosed techniques additionally train a machine learning model to predict attributes associated with knots in the spline-based representation using a loss function that includes regularization of velocities and/or accelerations associated with points in the time-varying scene, which further reduces artifacts, geometric distortion, and/or temporal jitter in the generated scene representations. Another technical advantage of the disclosed techniques is that, because the spline-based representation allows motion to be modeled in a smooth and/or spatially coherent manner, the disclosed techniques may adapt to complex motions and/or novel scenarios better than conventional approaches that use priors and/or constraints to mitigate geometric distortions and/or artifacts. These technical advantages provide one or more technological improvements over prior art approaches.

1. In some embodiments, a computer-implemented method for determining a time-varying deformation associated with a scene comprises matching a query time to a time interval associated with the scene; generating, via execution of a machine learning model, (i) a first set of attributes associated with a set of canonical coordinates in the scene at a starting time of the time interval and (ii) a second set of attributes associated with the set of canonical coordinates at an ending time of the time interval; computing a third set of attributes associated with the set of canonical coordinates at the query time based on a spline interpolation associated with the first set of attributes and the second set of attributes; and generating a representation of the scene at the query time based on the third set of attributes.

2. The computer-implemented method of clause 1, further comprising determining an additional representation of the scene at an additional query time that temporally follows the ending time based on a propagation of a position included in the second set of attributes using a velocity included in the second set of attributes.

3. The computer-implemented method of any of clauses 1-2, further comprising determining, based on a set of edits to one or more key frames associated with the scene, (i) a first set of updated attributes associated with the set of canonical coordinates at the starting time and (ii) a second set of updated attributes associated with the set of canonical coordinates at the ending time; computing a third set of updated attributes associated with the set of canonical coordinates based on an additional spline interpolation associated with the first set of updated attributes and the second set of updated attributes; and generating an additional representation of the scene at the query time based on the third set of updated attributes.

4. The computer-implemented method of any of clauses 1-3, wherein generating the first set of attributes and the second set of attributes comprises determining (i) a first set of temporal weights associated with the starting time and (ii) a second set of temporal weights associated with the ending time; generating (i) a first time-variant spatial encoding based on the first set of temporal weights and the set of canonical coordinates and (ii) a second time-variant spatial encoding based on the second set of temporal weights and the set of canonical coordinates; and generating (i) the first set of attributes based on the first time-variant spatial encoding and (ii) the second set of attributes based on the second time-variant spatial encoding.

5. The computer-implemented method of any of clauses 1-4, wherein generating the first set of attributes and the second set of attributes further comprises aggregating features corresponding to the first time-variant spatial encoding or the second time-variant spatial encoding; and decoding, via execution of one or more layers included in the machine learning model, the aggregated features into the first set of attributes or the second set of attributes.

6. The computer-implemented method of any of clauses 1-5, wherein the first set of attributes and the second set of attributes are further generated based on at least one of a time-invariant base encoding or a set of residual encodings.

7. The computer-implemented method of any of clauses 1-6, wherein computing the third set of attributes comprises determining, within the time interval, a relative time that corresponds to the query time; and performing the spline interpolation based on the relative time, the first set of attributes, and the second set of attributes.

8. The computer-implemented method of any of clauses 1-7, wherein the representation of the scene comprises a three-dimensional (3D) Gaussian that is parameterized based on the third set of attributes.

9. The computer-implemented method of any of clauses 1-8, wherein the first set of attributes and the second set of attributes comprise at least one of a position or a velocity.

10. The computer-implemented method of any of clauses 1-9, wherein the spline interpolation is associated with a cubic Hermite spline.

11. In some embodiments, one or more non-transitory computer-readable media store instructions that, when executed by one or more processors, cause the one or more processors to perform the steps of matching a query time to a time interval associated with a scene; generating, via execution of a machine learning model, (i) a first set of attributes associated with a set of canonical coordinates of a three-dimensional (3D) Gaussian in the scene at a starting time of the time interval and (ii) a second set of attributes associated with the set of canonical coordinates at an ending time of the time interval; computing a third set of attributes associated with the set of canonical coordinates at the query time based on a spline interpolation associated with the first set of attributes and the second set of attributes; and generating a representation of the scene at the query time based on the third set of attributes.

12. The one or more non-transitory computer-readable media of clause 11, wherein the instructions further cause the one or more processors to perform the steps of determining, based on a set of edits to one or more key frames associated with the scene, (i) a first set of updated attributes associated with the set of canonical coordinates at the starting time and (ii) a second set of updated attributes associated with the set of canonical coordinates at the ending time; computing a third set of updated attributes associated with the set of canonical coordinates based on an additional spline interpolation associated with the first set of updated attributes and the second set of updated attributes; and generating an additional representation of the scene at the query time based on the third set of updated attributes.

13. The one or more non-transitory computer-readable media of any of clauses 11-12, wherein the set of edits is associated with at least one of an appearance or a pose of an object in the scene.

14. The one or more non-transitory computer-readable media of any of clauses 11-13, wherein generating the first set of attributes and the second set of attributes comprises determining (i) a first set of temporal weights associated with the starting time and (ii) a second set of temporal weights associated with the ending time; generating (i) a first time-variant spatial encoding of the set of canonical coordinates based on the first set of temporal weights and (ii) a second time-variant spatial encoding of the set of canonical coordinates based on the second set of temporal weights; and generating (i) the first set of attributes based on the first time-variant spatial encoding and (ii) the second set of attributes based on the second time-variant spatial encoding.

15. The one or more non-transitory computer-readable media of any of clauses 11-14, wherein the first time-variant spatial encoding and the second time-variant spatial encoding are further generated based on a projection of the set of canonical coordinates onto at least one of a set of triplanes or a set of triaxes.

16. The one or more non-transitory computer-readable media of any of clauses 11-15, wherein generating the first set of attributes and the second set of attributes further comprises aggregating features associated with the projection of the set of canonical coordinates; and decoding, via execution of one or more layers included in the machine learning model, the aggregated features into the first set of attributes or the second set of attributes.

17. The one or more non-transitory computer-readable media of any of clauses 11-16, wherein the starting time corresponds to a first knot in a spline representing a temporal trajectory associated with the set of canonical coordinates and the ending time corresponds to a second knot in the spline.

18. The one or more non-transitory computer-readable media of any of clauses 11-17, wherein the representation of the scene comprises a rendering of the scene.

19. The one or more non-transitory computer-readable media of any of clauses 11-18, wherein the third set of attributes comprises at least one of a position, a velocity, or an acceleration.

20. In some embodiments, a system comprises one or more memories that store instructions, and one or more processors that are coupled to the one or more memories and, when executing the instructions, are configured to perform the steps of matching a query time to a time interval associated with a scene; generating, via execution of a machine learning model based on the query time and a set of canonical coordinates of a three-dimensional (3D) Gaussian in the scene, (i) a first set of deformed coordinates at a starting time of the time interval and (ii) a second set of deformed coordinates at an ending time of the time interval; computing a third set of deformed coordinates at the query time based on a spline interpolation associated with the first set of deformed coordinates and the second set of deformed coordinates; and generating a representation of the scene at the query time based on the third set of deformed coordinates.

21. In some embodiments, a computer-implemented method for generating a neural deformation model comprises inputting, into a machine learning model, (i) a set of canonical coordinates in a scene and (ii) one or more times included in a temporal trajectory of the scene; generating, via execution of the machine learning model, one or more sets of attributes associated with the set of canonical coordinates and the one or more times; computing one or more losses based on (i) a velocity included in the one or more sets of attributes and (ii) one or more representations of the scene at the one or more times; and training the machine learning model based on the one or more losses.

22. The computer-implemented method of clause 21, further comprising generating, via execution of the trained machine learning model, an additional set of deformed attributes associated with the set of canonical coordinates at a query time; and generating a representation of the scene at the query time based on the additional set of deformed attributes.

23. The computer-implemented method of any of clauses 21-22, further comprising updating one or more sets of features associated with the set of canonical coordinates and the one or more times based on the one or more losses.

24. The computer-implemented method of any of clauses 21-23, wherein generating the one or more sets of attributes comprises determining the one or more sets of features based on a projection of the set of canonical coordinates and the one or more times onto at least one of a set of triplanes or a set of triaxes; and decoding, via execution of one or more layers included in the machine learning model, the one or more sets of features into the one or more sets of attributes.

25. The computer-implemented method of any of clauses 21-24, further comprising updating one or more sets of temporal weights associated with the one or more times based on the one or more losses.

26. The computer-implemented method of any of clauses 21-25, wherein the one or more losses comprise a velocity loss that is computed between the velocity and a set of velocities associated with a neighborhood of the set of canonical coordinates.

27. The computer-implemented method of any of clauses 21-26, wherein the one or more losses comprise an acceleration loss that is computed based on an acceleration included in the one or more sets of attributes.

28. The computer-implemented method of any of clauses 21-27, wherein the one or more losses comprise a reconstruction loss that is computed between (i) the one or more representations of the scene generated based on the one or more sets of attributes and (ii) one or more ground truth representations of the scene.

29. The computer-implemented method of any of clauses 21-28, wherein the one or more times are associated with one or more frames depicting the scene.

30. The computer-implemented method of any of clauses 21-29, wherein the machine learning model comprises a multilayer perceptron.

31. In some embodiments, one or more non-transitory computer-readable media store instructions that, when executed by one or more processors, cause the one or more processors to perform the steps of inputting, into a machine learning model, (i) a set of canonical coordinates in a scene and (ii) one or more times included in a temporal trajectory of the scene; generating, via execution of the machine learning model, one or more sets of attributes associated with the set of canonical coordinates and the one or more times; computing one or more losses based on (i) a velocity included in the one or more sets of attributes and (ii) one or more representations of the scene generated from the one or more sets of attributes and a 3D Gaussian parameterization of the scene; and training the machine learning model based on the one or more losses.

32. The one or more non-transitory computer-readable media of clause 31, wherein the instructions further cause the one or more processors to perform the step of updating one or more sets of temporal weights associated with the one or more times based on the one or more losses.

33. The one or more non-transitory computer-readable media of any of clauses 31-32, wherein generating the one or more sets of attributes comprises generating one or more time-variant spatial encodings based on the set of canonical coordinates and the one or more sets of temporal weights; and decoding, via execution of one or more layers included in the machine learning model, the one or more time-variant spatial encodings into the one or more sets of attributes.

34. The one or more non-transitory computer-readable media of any of clauses 31-33, wherein the instructions further cause the one or more processors to perform the step of updating one or more sets of features associated with the set of canonical coordinates and the one or more times based on the one or more losses.

35. The one or more non-transitory computer-readable media of any of clauses 31-34, wherein the one or more times are associated with one or more knots in a spline-based representation of the temporal trajectory.

36. The one or more non-transitory computer-readable media of any of clauses 31-35, wherein the one or more losses comprise a velocity loss that is computed between the velocity and a set of velocities associated with a neighborhood of the set of canonical coordinates.

37. The one or more non-transitory computer-readable media of any of clauses 31-36, wherein the one or more losses further comprise an acceleration loss that is computed based on an acceleration included in the one or more sets of attributes.

38. The one or more non-transitory computer-readable media of any of clauses 31-37, wherein the one or more losses further comprise a reconstruction loss that is computed between (i) the one or more representations of the scene generated based on the one or more sets of attributes and (ii) one or more ground truth representations of the scene.

39. The one or more non-transitory computer-readable media of any of clauses 31-38, wherein the one or more representations of the scene comprise one or more renderings of the scene at the one or more times.

40. In some embodiments, a system comprises one or more memories that store instructions, and one or more processors that are coupled to the one or more memories and, when executing the instructions, are configured to perform the steps of inputting, into a machine learning model, (i) a set of canonical coordinates in a scene and (ii) one or more times included in a temporal trajectory of the scene; generating, via execution of the machine learning model, one or more sets of attributes associated with the set of canonical coordinates and the one or more times; computing one or more losses based on (i) a velocity included in the one or more sets of attributes, (ii) an acceleration included in the one or more sets of attributes, and (iii) one or more representations of the scene generated from the one or more sets of attributes and a 3D Gaussian parameterization of the scene; and training the machine learning model based on the one or more losses.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a neural deformation model, the method comprising:
inputting, into a machine learning model, (i) a set of canonical coordinates in a scene and (ii) one or more times included in a temporal trajectory of the scene;
generating, via execution of the machine learning model, one or more sets of attributes associated with the set of canonical coordinates and the one or more times;
computing one or more losses based on (i) a velocity included in the one or more sets of attributes and (ii) one or more representations of the scene at the one or more times; and
training the machine learning model based on the one or more losses.

2. The computer-implemented method of claim 1, further comprising:
generating, via execution of the trained machine learning model, an additional set of deformed attributes associated with the set of canonical coordinates at a query time; and
generating a representation of the scene at the query time based on the additional set of deformed attributes.

3. The computer-implemented method of claim 1, further comprising updating one or more sets of features associated with the set of canonical coordinates and the one or more times based on the one or more losses.

4. The computer-implemented method of claim 3, wherein generating the one or more sets of attributes comprises:
determining the one or more sets of features based on a projection of the set of canonical coordinates and the one or more times onto at least one of a set of triplanes or a set of triaxes; and
decoding, via execution of one or more layers included in the machine learning model, the one or more sets of features into the one or more sets of attributes.

5. The computer-implemented method of claim 1, further comprising updating one or more sets of temporal weights associated with the one or more times based on the one or more losses.

6. The computer-implemented method of claim 1, wherein the one or more losses comprise a velocity loss that is computed between the velocity and a set of velocities associated with a neighborhood of the set of canonical coordinates.

7. The computer-implemented method of claim 1, wherein the one or more losses comprise an acceleration loss that is computed based on an acceleration included in the one or more sets of attributes.

8. The computer-implemented method of claim 1, wherein the one or more losses comprise a reconstruction loss that is computed between (i) the one or more representations of the scene generated based on the one or more sets of attributes and (ii) one or more ground truth representations of the scene.

9. The computer-implemented method of claim 1, wherein the one or more times are associated with one or more frames depicting the scene.

10. The computer-implemented method of claim 1, wherein the machine learning model comprises a multilayer perceptron.

11. One or more non-transitory computer-readable media storing instructions that, when executed by one or more processors, cause the one or more processors to perform the steps of:
inputting, into a machine learning model, (i) a set of canonical coordinates in a scene and (ii) one or more times included in a temporal trajectory of the scene;
generating, via execution of the machine learning model, one or more sets of attributes associated with the set of canonical coordinates and the one or more times;
computing one or more losses based on (i) a velocity included in the one or more sets of attributes and (ii) one or more representations of the scene generated from the one or more sets of attributes and a 3D Gaussian parameterization of the scene; and
training the machine learning model based on the one or more losses.

12. The one or more non-transitory computer-readable media of claim 11, wherein the instructions further cause the one or more processors to perform the step of updating one or more sets of temporal weights associated with the one or more times based on the one or more losses.

13. The one or more non-transitory computer-readable media of claim 12, wherein generating the one or more sets of attributes comprises:
generating one or more time-variant spatial encodings based on the set of canonical coordinates and the one or more sets of temporal weights; and
decoding, via execution of one or more layers included in the machine learning model, the one or more time-variant spatial encodings into the one or more sets of attributes.

14. The one or more non-transitory computer-readable media of claim 11, wherein the instructions further cause the one or more processors to perform the step of updating one or more sets of features associated with the set of canonical coordinates and the one or more times based on the one or more losses.

15. The one or more non-transitory computer-readable media of claim 11, wherein the one or more times are associated with one or more knots in a spline-based representation of the temporal trajectory.

16. The one or more non-transitory computer-readable media of claim 11, wherein the one or more losses comprise a velocity loss that is computed between the velocity and a set of velocities associated with a neighborhood of the set of canonical coordinates.

17. The one or more non-transitory computer-readable media of claim 16, wherein the one or more losses further comprise an acceleration loss that is computed based on an acceleration included in the one or more sets of attributes.

18. The one or more non-transitory computer-readable media of claim 16, wherein the one or more losses further comprise a reconstruction loss that is computed between (i) the one or more representations of the scene generated based on the one or more sets of attributes and (ii) one or more ground truth representations of the scene.

19. The one or more non-transitory computer-readable media of claim 11, wherein the one or more representations of the scene comprise one or more renderings of the scene at the one or more times.

20. A system, comprising:
one or more memories that store instructions, and
one or more processors that are coupled to the one or more memories and, when executing the instructions, are configured to perform the steps of:
inputting, into a machine learning model, (i) a set of canonical coordinates in a scene and (ii) one or more times included in a temporal trajectory of the scene;
generating, via execution of the machine learning model, one or more sets of attributes associated with the set of canonical coordinates and the one or more times;
computing one or more losses based on (i) a velocity included in the one or more sets of attributes, (ii) an acceleration included in the one or more sets of attributes, and (iii) one or more representations of the scene generated from the one or more sets of attributes and a 3D Gaussian parameterization of the scene; and
training the machine learning model based on the one or more losses.
